(19) United States
(12) Patent Application Publication
(10) Pub. No.: US 2006/0020992 A1
(43) Pub. Date: Jan. 26, 2006

(54) Weather/disaster alert system using a data network

(76) Inventors: Michael Anthony Pugel, Noblesville, IN (US); David Emery Virag, Indianapolis, IN (US)

Correspondence Address: THOMSON LICENSING INC., PATENT OPERATIONS, PO BOX 5312, PRINCETON, NJ, 08543-5312, US

(21) Appl. No.: 10/534,446

(22) PCT Filed: Aug. 25, 2003
(86) PCT No.: PCT/US03/26649

§ 371 Date: May 10, 2005

(30) Foreign Application Priority Data
Nov. 12, 2002 (US) 60425611

(51) Int. Cl. H04N 7/173; G08B 1/00

(52) U.S. Cl. 725/108; 340/531

(57) ABSTRACT

An alert receiver includes a discriminator, which receives encoded signals from a network. The encoded signals report an event from an information source coupled to the network, wherein the discriminator compares the encoded signals, which include codes designating geographic locations, to codes associated with specific localities to determine whether to alert a user. A warning device is responsive to a result of comparing the encoded signals to the codes associated with specific localities.

### FIELD OF INVENTION

The invention is related to the field of alert devices, in particular alert devices that receive an alert through a data network.

### BACKGROUND OF THE INVENTION

Unpredictable events such as weather storms, seismic activity or even terrorist attacks are dangerous situations that affect the safety and well being of bystanders. During these types of events the extent of injuries and property damage would be minimized if a warning were disseminated to an affected bystander in a timely manner.

Most distributed broadcasting networks, such as a cable network, satellite network, over the airwaves broadcast network, and the like, broadcast content that is disseminated through the use of local broadcast systems such as local affiliates. Typically, such local networks are able to broadcast warning messages when emergency circumstances arise. Such alert systems are limited because emergency broadcast information is not listened to or viewed, if a device used to receive such messages from a broadcaster is inactive or not tuned to the broadcaster transmitting such a message. Furthermore, with media consolidation and the elimination of independent local broadcast affiliates, more broadcast programming will originate and be controlled from a nationally based broadcast network instead of the level of the local broadcaster. Hence, more people will be receiving media programming from national sources such as EchoStar™ or DirecTV™ than from local sources (a local news affiliate) that deliver national instead of locally related programming. The national broadcaster therefore may lack the means to deliver an emergency message to a local audience, without interrupting a nationally based broadcast.

Also, national broadcasters may have difficulty delivering emergency messages. Such a message would have to be received at the central location of the national broadcaster before the message would be transmitted to local affiliates. In contrast, a local affiliate would have a quicker response time in delivering a message about an emergency because a local affiliate is probably closer in distance to a local user than the national broadcaster.

Therefore, a need exists for a system and method, which permits emergency information to reach an end user or potential victim effectively. A further need exists for a system and method, which also alerts individuals, which are not viewing or listening to a media channel/station.

### SUMMARY OF THE INVENTION

The invention includes an alert receiver that includes a discriminator, which receives encoded signals from a data network. The encoded signals report an event from an information source coupled to the network, wherein the discriminator compares the encoded signals, which include codes designating geographic locations, to codes associated with specific localities to determine whether to alert a user. A warning device is responsive to a result of comparing the encoded signals to the codes associated with specific localities. An alert system includes a receiver located at a user's location. The user's location has a code designation associated therewith. The receiver is coupled to a network from which a plurality of encoded reports is provided to the receiver. A discriminator decodes the encoded reports to determine those reports corresponding to the code designation associated with the user's location. A warning device is located at the user's location to inform a user of the reports corresponding to the code designation associated with the user's location.

The user's location has a code designation associated therewith. The receiver is coupled to a network, which carries television signals and receives television signals thereof. The receiver is also configured to receive and render encoded reports separate from audio and visual data. The receiver includes a discriminator, which deciphers the encoded reports to determine those reports corresponding to the code designation associated with the user's location. A warning device is located at the user's location to inform a user of the reports corresponding to the code designation associated with the user's location.

The invention is described in reference to the following four figures, although the principles of the invention can be applied to a satellite network, a cable network, a telecommunication based network, and other types of communications networks.

### BRIEF DESCRIPTION OF DRAWINGS

FIG. 1 is a schematic diagram of a system for alerting individuals of an event in accordance with one embodiment of the present invention;

FIG. 2 is a block diagram of a receiver employed in accordance with the present invention to alert individuals of an event;

FIG. 3 is a graph of a vertical blanking interval waveform for inserting analog data relevant to alerting a user of an event in accordance with one embodiment of the present invention; and

FIG. 4 is a block diagram of a data packet format for transmitting digital data relevant to alerting a user of an event in accordance with the present invention.

It should be understood that the drawings are for purposes of illustrating the concepts of the invention and are not necessarily the only possible configuration for illustrating the invention.

### DETAILED DESCRIPTION

The preferred embodiment of the invention operates in view of the SAME codes developed by the National Weather Service of the United States, although other types of geographic codes and weather related codes may be used. The SAME message is preferably an ASCII format message that may be around 50 or so bytes long.

The data structure for the SAME message is illustratively shown below in Table 1:

TABLE 1
Preamble - Header - Identifier - Event Code - Geographic area
code Purge time -Calendar date/time - Originator - End.
(- dash is sent in between each field code except before purge time)
Each component of the SAME message may include the following:
Preamble - sixteen bytes of $AB
Header - always ZCZC
Identifier- sent for voice message as WXR, others are possible
Event Code - in a table in standard, three letters
Geographic area code - set up as FIPS, in table can be multiple
codes of 6 letters
Purge time - shows delta from original issue time as a 4-digit number,
used to indicate length of warning time
Calendar time/date - given in numeric Julian format using UTC
Originator - station id call letters
End - sent as NNNN

The letters, e.g., AB, ZCZC, WXR and NNNN designate data codes used for the set-up of a SAME message. These codes may be used to trigger or synchronize a receiver to the data stream. The specific identifier “WXR” says the message is a voice message (voice is available) from the National Weather Service. However, a plurality of sources may be employed and this identifier would allow for other sources to originate the message (through other means as well), and still fit into the present system. The present invention provides a method and system for disseminating event information over a data network (such as a satellite network, cellular network, television broadcast network, cable, modem, digital subscriber line, and the like). Event information may be designated for delivery to particular local areas. These areas may be determined at the information source and/or an intermediary location, for example, a head end network for a cable system or at the destination, for example, in an individual's home. Once the local areas that would be affected the most are determined, the system of the present invention signals a receiver device at the individual locations in the local areas. The signals can provide an audible or visual alert to inform users that a message or data about an event is being relayed. Then, the data or information is conveyed over the network in accordance with the present invention. The alert signals may be continued or a set duration or continue for the duration of the event.

It is to be understood that the present invention is described in terms of an illustrative cable network system; however, the present invention is much broader and may include any network system, which includes the capability of sending event messages and signaling across a network. For example, the present invention may be employed in any type of data network. It should also be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

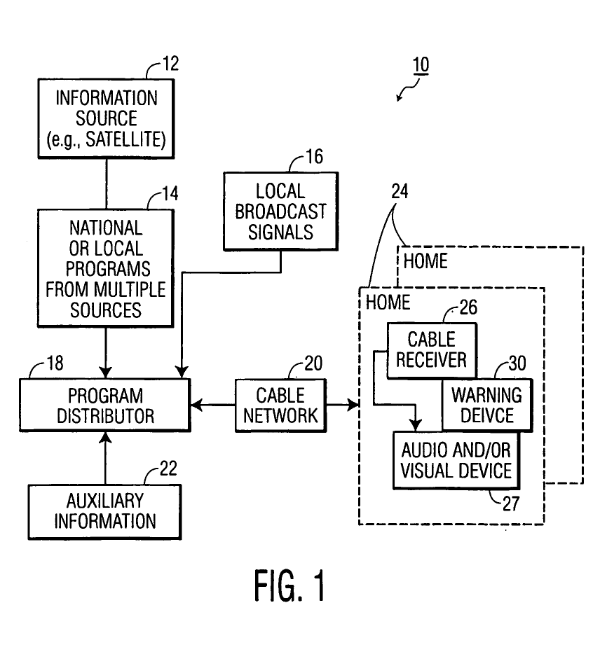

Referring now in specific detail to the drawings in which like reference numerals identify similar or identical elements throughout the several views, and initially to FIG. 1, communication network system 10 is shown in accordance with the present invention. Communication network 10 (also referred to as a data network) may include one or more information sources 12, which may include satellites, broadcast stations, weather stations, cellular sites or any other transmission source. In the illustrative embodiment, source(s) 12 provides data and information to program distributor 18. In a preferred embodiment, a satellite network, as information source 12, provides programming 14 to program distributor 18. In addition, program distributor 18 may receive information from multiple sources. For example, cable network program distributor 18 may receive information from local broadcast stations 16, such as local radio stations, from satellites 12, or from auxiliary sources 22, such as telephone or other cable or wireless networks.

During an alert situation, such as weather alert or terrorist attack, an agency such as the United States Office of Homeland Security or the National Weather Service will give notification about the event through an alarm notification. Different systems are already known in the art such as the SAME time weather alert system or the Emergency Managers Weather Information Network (EMWIN), both systems are used by created by the National Oceanic Atmospheric Administration (NOAA). These alerts are typically required to be broadcasted by local broadcaster 16 to a user's home location.

In the present invention, the alerts are transmitted to information source 12, instead of just using local broadcaster 16. The alert is encoded as part of the signal used by information source 12 to communicate typical program information. For example, information source 12 is a satellite or cable source that transmits programming and/or information in the form of an MPEG-2 compatible data stream, for this exemplary embodiment of the invention, although any other formats of data streams may be used. The alert is formatted into the auxiliary data fields or headers of packets forming the MPEG-2 data stream, although other sections of a packet may be used. Continuing with the present example, a voice based alert for the New York area with the corresponding SAME geographical code of 034025 is issued by NOAA, which is directly transmitted to information source 12. It should be noted that although SAME information based alerts typically consist of text, types of information such as video, audio, text, a graphic weather map, and the like optionally accompany an SAME alert.

Once the alert is received by information source 12, the voice alert is sampled into a format that allows the alert to be embedded within the MPEG-2 data stream; the sampling operation is performed as known in the art. Data is also added to the data stream noting that the digitized alert corresponds to a SAME geographic code of 034025; typically the geographic code corresponds to a user location. Other alerts, such a video or other audio information, are processed similarly, but text based alerts would not typically require such a digitization step.

The data stream is transmitted from information source 12 to a multiple system operator (MSO) as program distributor 18, such as a cable network head end or other source that distributes programming to users. At the point of program distributor 18, a discriminator device is in place that is capable of filtering inserted alert messages in a received data stream from data used for rendering programming such as television shows and music. In the present case, program distributor 18 distributes programming to an audience corresponding to the New York geographic area.

Upon receiving the MPEG-2 data stream from information source 12, program distributor 18 parses the embedded alert message from the user data fields present in the data stream. During the parsing operation, program distributor 18 matches the SAME geographic code corresponding to the embedded alert message to its designated subscriber base (as being the New York area).

Upon this match, program distributor 18, reconstitutes embedded alert message into a voice alert that is transmitted to home 24 via cable network 20. Preferably, this voice alert supercedes any other audio transmission being broadcasted over cable network 20. Alternatively, any alert message transmitted by program distributor 18 is rendered as a combination of audio and/or video at the point of home 24.

When transmitting alert messages, program distributor 18 inserts pertinent information from the reporting sources for dissemination within a cable network 20. The pertinent information, such as news of an event or other information can be sent in a number of ways. The signals may be sent, for example, as closed captioning information on analog based channels, the information may be sent in a forward data channel in a network using security, or the information may be sent using some of the bandwidth of the digital channels. Data/information sent over cable network 20 from cable program distributor 18 is sent to user homes 24. Users have a cable or other type of receiver 26, which receives the signals from the cable network, processes the signals and informs/warns the user of the event. The signals received from program distributor 18 are preferably encoded with locality information. This includes information about local areas that are affected by the event.

When communicating alert information from a reporting source to cable network 20, program distributor 18 operates either as a relay of alert information or as an alert author. Specifically, when operating as a relay of alert information, program distributor 18 essentially repeats alert information from a reporting source with very little or no change to the content the alert information. For example, a reporting source, such as information source 12, communicates a message about an impending thunderstorm for the metropolitan New York area in a SAME format to program distributor 18. This message is converted by program distributor 18 into a format capable of being transmitted in a MPEG-2 data transport stream to homes 24 via cable network 20. The contents of the message concerning a thunderstorm warning for the New York area has not changed in this conversion process.

Alternatively, when program distributor 18 receives the SAME based message, as described above, program distributor 18 adds additional information to the message to become an alert author. The type of information added may be audio, video, and/or text information that supplements the alert message. For example, upon receiving the SAME based message, program distributor 18 adds graphic information that renders a weather map for display on a display device 27 connected to cable network 20, or audio information that renders a computer synthesized voice speaking the contents of the weather message for output on audio device 27; other forms of supplemental information are to be selected based on the preferences of program distributor 18. Advantageously, a program distributor 18 that acts as an alert author is able to notify users without warning device about an impending alert condition. Correspondingly, users with a warning device also benefit from the supplemental information added to an alert message from program distributor 18 when rendered on audio and/or visual device 27.

In another embodiment of the present invention, alert messages are obtained and inserted at a cable system, for example from local broadcast signal 16. The program distributor 18 first receives one or more alert messages. These messages may come from several sources, including monitoring the over-the-air National Weather Service Broadcasts, or possibly through a connection to the EMWIN network directly, via the Internet or otherwise. The program distributor 18 then separates a key message, e.g., the SAME information from the other information.

This SAME message is then inserted as additional data into the data stream of a channel by appending and inserting an identifier PID (Program Identifier) into the digital transmission following the appropriate format rules for the signal. The PID may be established through a program guide function, as a predefined fixed number or by other techniques.

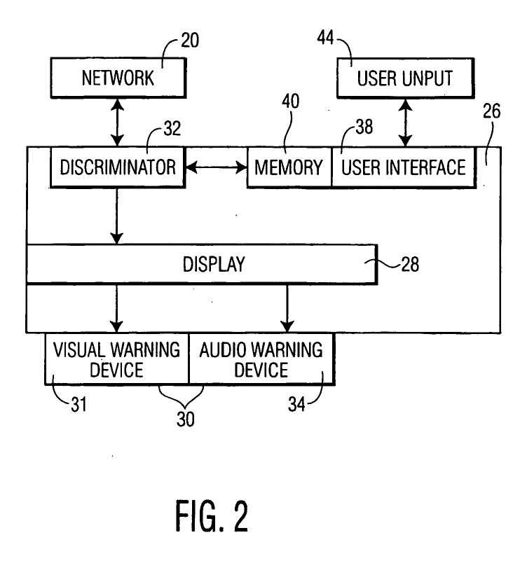

This PID is used in receiver 26 to determine what kind of information has been received. In this case, the PID identifies the information as an alert message, not a video or audio signal, and sends this information to the receiver's alert message identifier in receiver 26 and discriminator 32 (FIG. 2) for processing. The small size of the alert message makes it easy to insert into all program channels relatively simultaneously. Furthermore, the signals can be sent over digital networks. Other embodiments for use with analog signals using VBI insertion are also envisioned in a similar manner.

Receiver 26 may include a set top box, a television, a computer, a radio device, a cable or telephone modem or any other device equipped to relay warning information to a user. Since each home 24 may include a different receiver device or different setup, it is likely that, for a cable system, the data will need to be sent in a number of ways over a number of channels to ensure that all homes can and do receive the information.

Advantageously, since cable network 20 is usually regionally operated, hence program distributor 18 has to select which alert message(s) are rendered for the viewing area being serviced. This may be done manually or automatically depending on the method of receiving the information at program distributor 18. For example, the messages received at the headend network may be encoded as to which areas would be affected by the event. Alternately, once received, the information may be encoded at the program distributor 18 based on the locality to be alerted of the event. The total amount of data sent is quite small for a typical alert message; therefore, it is not anticipated that a significant loss of channel bandwidth will occur.

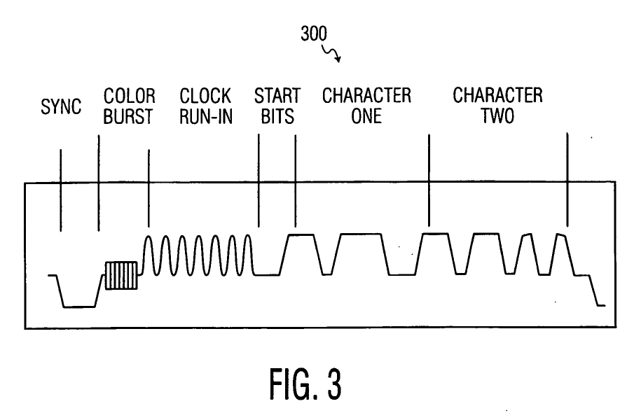

FIG. 3 shows an example of a VBI insertion for transferring a signal to a cable network using an analog format. VBI data is preferably input at the source of the signal. Signal 300 shows a Line 21 set-up for sending a message using, for example, a closed captioning system to transfer alert data in accordance with the present invention. This is known as the vertical blanking interval (or VBI). In the vertical blanking interval, there are typically 40 horizontal lines (these lines are above and/or below the edge of the picture screen and do not contain video information). Line 21 has been designated as the insertion point for closed captioning information. There are other insertion modes, e.g., teletext, XDS, etc., which all use these lines (more of them) typically somewhere between 5 and 25. Hence, the phrase “line 21”.

The SAME message can be inserted two characters (Character One and Character Two in FIG. 3) at a time (directly) into the VBI. It may take 25-30 of these, for example, to send the entire message, which is less than 1 second of real time (the VBI occurs 60 times a second). This message can be inserted several times, and still not impact the conventional closed caption operation.

There are several Electronics Industry Alliance (EIA) specifications that can govern operation in the VBI as known in the art, for example, EIA608 titled “LINE 21 DATA SERVICES” (original specification for closed captioning), or EIA746 titled “TRANSPORT OF INTERNET UNIFORM RESOURCE LOCATOR (URL) INFORMATION USING TEXT-2 (T-2) SERVICE” (enhancements for interactive capabilities). There are products available both in hardware and software that allow VBI insertion capabilities (either for direct closed captioning or for augmenting the closed captioning). Using available devices, the VBI is employed to transfer warning data to a cable box or other device. Once the data is retrieved, it may be decoded and analyzed to determine if the information is appropriate for the present geographic location. If the information is appropriate with the location in question, the information is rendered for display and/or a warning alert is activated.

In a digital format, the opportunities are not nearly as restrictive in the analog format. One approach may include a digital format version for a VBI insertion. (See e.g., EIA746).

Alternately, the data can be entered as auxiliary data with its own PID. The advantage here may be that this PID can be separately managed by the provider and may avoid potential issues with other formatting systems and that the data need be sent only once per transponder. One approach would be to use SMPTE (Society of Motion Picture Television Engineers) standards for serial bit stream video (SMPTE292 titled “TELEVISION—BIT-SERIAL DIGITAL INTERFACE FOR HIGH-DEFINITION TELEVISION SYSTEMS” is the top level specification). SMPTE 291 titled “TELEVISION—ANCILLARY DATA PACKET AND SPACE FORMATTING” specifies the format and method for insertion of ancillary data into a data stream. This data packet could be encapsulated within a valid MPEG transport packet for transmission across a digital cable or digital satellite network.

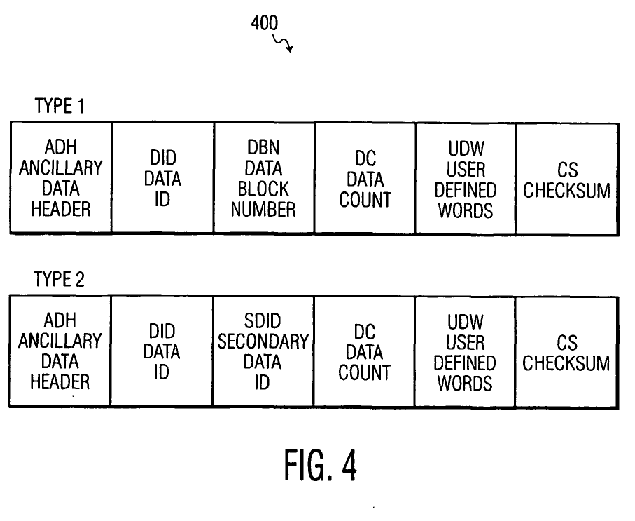

FIG. 4 shows one example for transferring a signal to a cable network using a digital format. Data format 400 shows a SMPTE format where Type 1 or Type 2 packets may be used. An Ancillary Data Header (ADH) functions to route the data to an appropriate destination. Data ID (DID) can be pre-defined through SMPTE to indicate alert data for display (SMPTE keeps the registry of Data IDs). In this way, a packet sent in an audio or video stream can be identified, removed and processed by discriminator 32 to provide an alert warning and message. The Data Block Number (DBN) is used to string multiple packets together. This may not be needed for this data string so a value of “0” can be used. The Data Count (DC) indicates a number of bytes (in the present case, somewhere around 50). The data would then be inserted in a User Data Word (UDW) slot. A Check Sum (CS) may be computed to provide error detection for the packet. Advantageously, the entire message can be sent in a single packet. There is a plurality of other methods for sending this data through a digital stream. Type 2 packets including a Secondary Data ID (SDID) may also be employed with type 1 packets to convey additional information or to route messages to different device (e.g., a warning device/alarm) in a receiver 26.

Referring back to FIG. 1, Receiver 26 provides information received from program distributor 18 to a user's audio or video rendering device 27, which may include a warning device 30. Warning device 30 may also be included as part of receiver 26 or externally connected to receiver 26. Receiver 26 preferably discriminates or decodes the encoded information received from program distributor 18 to provide information to localities, which would benefit from the information.

One useful operation of receiver 26 arises when receiver 26 is employed for its originally intended mode of operation, e.g., as a television, In this case, receiver 26 receives a signal for display on a television, and this signal is not a re-broadcast of a local transmission over an air station. Most over-the-air stations provide local weather and public safety alert information as an addition to or as preemption to normal program material. However, stations that originate nationally, or stations created by a cable network (e.g., movie channels) will, in general, not include this information.

Once the information is introduced into program distributor 18 and sent into the cable system 20, receiver 26 discriminates this information and automatically preempts or inserts the warning information into the television display. That is, the television program may be preempted at particular localities in accordance with discriminated codes. This may also include data streaming or closed captioning across a portion of the screen of a television, for example. In addition, a picture in a picture (PIP) application may be initiated to convey the warning or alert. In this manner the cable system extends the features of the over-the-air broadcasts to potentially all stations that the cable system carries.

Referring to FIG. 2, receiver 26 is illustratively shown for alerting users of an event. Receiver 26 may include a set top box, or other devices, such as a radio, a telephone, a television, a cable modem, a telephone modem or other device capable of audio and/or visual display for warning a user. Receiver 26 includes an information discriminator 32. Receiver 26 includes a setup screen or display 28 to enable, for example a “weather-alert” feature. Within this screen 28, the user may be asked what types of alerts to be notified of and for what region of the country. Moreover, a user may specify the source of the alert preferred (e.g., from a local program distributor over a national broadcaster). This information may also be provided from the source or program distributor 18. Receiver 26 preferably includes warning device 30 which may further include one or more of display 28, a visual warning device 31 (e.g., a flashing light) and/or an audio warning device 34 (e.g., a speaker).

In accordance with one embodiment of the present invention, receiver 26 employs the system described by the current NWS VHF FM radio broadcast network that now utilizes the SAME (Specific Area Message Encoding) system. The SAME system permits for specific messaging to selected areas of a coverage region. Options exist at both a transmit end and a receive end of the system to specify which messages will be received. For example, program distributor 18 (FIG. 1) may discriminate which region or regions will be read out on the display or be responsive to warning signals from specific regions. Alternately, receiver 26 may discriminate whether it is situated to receive a given message (e.g., receiver 26 is located in a specified locale).

The SAME system in NWS uses what are called FIPS (Federal Information Processing System) codes, which include coded words 6 bytes long. These words segment the United States into regions, states, and counties. In other embodiments, other defining encoding may be employed, for example, zip codes or even addresses of individual users. The user can select which messages are displayed by identifying the FIPS regions the user wants to be notified of. User interface 38, controlled by user input 44 may be employed to make the appropriate selections and/or program receiver 26. Given the regional operation of a cable system, a simpler or more complicated system may be employed. The cable receiver 26 may simply monitor the incoming messages from program distributor 18 and determine which messages to display based on user preferences, locale codes, date, time of day or any other criteria that can be programmed into the system. Predetermined criteria, e.g., FIPS codes, are programmed into receiver and compared to the encoded signals to determine if the information receive should be displayed and an alarm or alert mechanism activated.

In one embodiment, a user may be able to program a receiver memory 40 with one or more codes to receive information from program distributor 18. For example, a user may program locale codes for their office and home, or their present location and the location of a friend or relative. In an optional embodiment of the present invention, stock and/or bond codes or market indexes may be entered into receiver 26 to alert a user of the status of financial events. Personal or other information may be programmed into receiver 26 to permit a reminder warning or other indicator to be made to the user if the event occurs (e.g., a date event) or a condition is met (e.g., the temperature of a remote location reaches a certain value).

A number of options exist for displaying the message or information on display 28. For example, a banner, generated by the receiver, similar to a closed caption message could be inserted to indicate an “alert” state and/or information about the event or condition, which caused the “alert” state. Additionally the receiver could emit a beeping tone, or some other indicator on the receiver itself as described above. Advantageously, the “alert” state is provided at any time regardless of whether the user is viewing a particular channel or listening to a particular station. Receiver 26 is preferably always on and ready to provide an alert at any time in accordance with the present inventions. The system 10 is easily implemented and easy to use to provide a means of communications alert for those people not immediately addressable by other local alert methods.

In one embodiment, warning device 30 includes different responses to different reports. For example, audio warning device 34 may include a plurality of prerecorded messages or may include a tone or sound, which designates a level of importance or immediacy of the report. Visual warning device 31 may include a plurality of indicators, such as lights, which may include different colors or flash at different rates or intensities to designate a level of importance or immediacy of the report. In other embodiments, the warning device 30 may include a software, a hardware or a combination of both to re-tune a device to a different pre-selected channel or station for a local off-air broadcast, which may relay information associated with the alert or the event. It is to be understood that warning device 30 may be included in receiver 26 or externally connected to receiver 26 by a wired or wireless connection.

Having described preferred embodiments for weather/disaster alert system using a cable network (which are intended to be illustrative and not limiting). It is noted that modifications and variations can be made by persons skilled in the art in light of the above teachings. It is therefore to be understood that changes may be made in the particular embodiments of the invention disclosed which are within the scope and spirit of the invention.

1. An alert receiver, comprising:
a discriminator which receives encoded signals from a network, the encoded signals for reporting an event from an information source coupled to the network, wherein the discriminator compares the encoded signals, which include codes designating geographic locations, to codes associated with specific localities to determine whether to alert a user; and
a warning device responsive to a result of comparing the encoded signals to the codes associated with specific localities.

2. The alert receiver as recited in claim 1, wherein the warning device includes an audible alarm.

3. The alert receiver as recited in claim 1, wherein the warning device includes a visual alarm.

4. The alert receiver as recited in claim 1, wherein the codes associated with specific localities including codes designating a user's geographic location.

5. The alert receiver as recited in claim 4, wherein the codes designating geographic locations include Federal Information Processing System (FIPS) codes.

6. The alert receiver as recited in claim 1, wherein the encoded signals include Specific Area Message Encoding (SAME).

7. The alert receiver as recited in claim 1, further comprising a display, which renders textual messages from the encoded signals when a comparison criterion is met.

8. The alert receiver as recited in claim 1, wherein the event is associated with geographic codes and the codes associated with specific localities designate an aspect of the receiver such that when one or more of the event codes match one or more of the codes associated with specific localities, the warning device responds.

9. The alert receiver as recited in claim 8, wherein the aspect of the receiver includes a code designating the receiver's location.

10. The alert receiver as recited in claim 8, wherein the aspect of the receiver includes a plurality of codes designating geographic locations.

11. The alert receiver as recited in claim 1, wherein the alert receiver is coupled to a head end station through a cable network.

12. The alert receiver as recited in claim 1, wherein the receiver is always on for being responsive to the encoded signals.

13. The alert receiver as recited in claim 1, wherein the encoded signals include characters inserted into a vertical blanking interval (VBI) of a received television signal.

14. The alert receiver as recited in claim 1, wherein the encoded signals are included in a data packet inserted into a data stream, wherein the data packet is identifiable as an alert message.

15. An alert system, comprising:
a receiver located at a user's location, the user's location having a code designation associated therewith;
the receiver being coupled to a network from which a plurality of encoded reports are provided to the receiver;
a discriminator which deciphers the encoded reports to determine those reports corresponding to the code designation associated with the user's location; and
a warning device located at the user's location to inform a user of the reports corresponding to the code designation associated with the user's location.

16. The alert system as recited in claim 15, wherein the warning device includes at least one of an audible alarm and a visual alarm.

17. The alert system as recited in claim 15, wherein the encoded reports include codes designating geographic locations.

18. The alert system as recited in claim 17, wherein the codes include Federal Information Processing System (FIPS) codes.

19. The alert system as recited in claim 15, wherein the encoded reports include Specific Area Message Encoding (SAME).

20. A method for receiving alert message concerning an emergency situation affecting a user location, the user location having a code designation associated therewith comprising the steps of:
receiving the alert message comporting to a data format;
deciphering the alert message into a report with a corresponding code designation; and
rendering an alert upon a match of the code designation associated with the user location to the corresponding code designation of the report.
